(19) United States
(12) Patent Application Publication
(10) Pub. No.: US 2018/0165855 A1
(43) Pub. Date: Jun. 14, 2018

(54) Systems and Methods for Interactive Virtual Makeup Experience

(71) Applicant: Perfect Corp., New Taipei City (TW)

(72) Inventors: Chih-Yu Cheng, Taipei City (TW); Chia-Chen Kuo, Taipei (TW); Ho-Chao Huang, New Taipei City (TW)

(21) Appl. No.: 15/822,268

(22) Filed: Nov. 27, 2017

Related U.S. Application Data
(60) Provisional application No. 62/434,335, filed on Dec. 14, 2016.

(51) Int. Cl. G06T 11/60; G06F 3/0488; G06T 7/60; G06T 7/73; G06T 7/90; G06T 7/136; G06F 3/0484; G06T 7/33

(52) U.S. Cl. CPC G06T 11/60; G06F 3/0488; G06T 7/60; G06T 7/73; G06T 7/90; G06T 7/194; G06F 3/04845; G06T 7/33; G06T 2200/24; G06T 2207/20221; G06T 7/136

(57) ABSTRACT

A computing device for providing a virtual fingernail cosmetic experience generates an initial pattern located at a first position on a user interface displaying a digital image, the digital image further displaying a target object. The computing device obtains user input for relocating the initial pattern from the first position to a location in the target object, and in response to relocating the initial pattern, extracts image attributes of the digital image. The computing device estimates at least one of: a shape, size, and an orientation of the target object utilizing the extracted image attributes, wherein the initial pattern comprises a graphic simulating fingernail polish and the target object comprises a fingernail. The computing device generates a transformed pattern from the initial pattern utilizing at least one of: the estimated shape, size, and orientation of the target object, the transformed pattern being superimposed on the target object.

### CROSS-REFERENCE TO RELATED APPLICATION

This application claims priority to, and the benefit of, U.S. Provisional Patent Application entitled, “An Interactive System for Virtual Makeup Experience,” having Ser. No. 62/434,335, filed on Dec. 14, 2016, which is incorporated by reference in its entirety.

### TECHNICAL FIELD

The present disclosure generally relates to editing multimedia content and more particularly, to an interactive system and method for improving the virtual makeup experience for a user.

### BACKGROUND

As smartphones and other mobile devices have become ubiquitous, people have the ability to take digital images virtually any time. However, the process of selecting and incorporating special effects to further enhance digital images can be challenging and time-consuming. For example, when applying special effects to simulate the appearance of fingernail polish, it can be difficult to apply the special effects to the individual's fingernails due to the difficulty in accurately estimating the size and shape of the fingernail regions.

### SUMMARY

Systems and methods for providing a virtual fingernail cosmetic experience are disclosed. In a first embodiment, a computing device generates an initial pattern located at a first position on a user interface displaying a digital image, the digital image further displaying a target object. The computing device obtains user input for relocating the initial pattern from the first position to a location in the target object, and in response to relocating the initial pattern, extracts image attributes of the digital image. The computing device estimates at least one of: a shape, size, and an orientation of the target object utilizing the extracted image attributes, wherein the initial pattern comprises a graphic simulating fingernail polish and the target object comprises a fingernail. The computing device generates a transformed pattern from the initial pattern utilizing at least one of: the estimated shape, size, and orientation of the target object, the transformed pattern being superimposed on the target object.

Another embodiment is a system that comprises a display, a memory device storing instructions, and a processor coupled to the memory device. The processor is configured by the instructions to generate an initial pattern, the initial pattern being superimposed at a first position on a user interface displaying a digital image, the digital image further displaying a target object, wherein the initial pattern comprises a graphic simulating fingernail polish and the target object comprises a fingernail. The processor is further configured by the instructions to obtain user input for relocating the initial pattern from the first position to a location in the target object. In response to relocating the initial pattern, the processor extracts image attributes of the digital image. The processor is further configured by the instructions to estimate at least one of: a shape, size, and an orientation of the target object utilizing the extracted image attributes and generate a transformed pattern from the initial pattern utilizing at least one of: the estimated shape, size, and orientation of the target object, the transformed pattern being superimposed on the target object.

Another embodiment is a non-transitory computer-readable storage medium storing instructions to be implemented by a computing device having a processor. The instructions, when executed by the processor, cause the computing device to generate an initial pattern, the initial pattern being superimposed at a first position on a user interface displaying a digital image, the digital image further displaying a target object, wherein the initial pattern comprises a graphic simulating fingernail polish and the target object comprises a fingernail. The instructions, when executed by the processor, further cause the computing device to obtain user input for relocating the initial pattern from the first position to a location in the target object. In response to relocating the initial pattern, the processor extracts image attributes of the digital image. The instructions, when executed by the processor, further cause the computing device to estimate at least one of: a shape, size, and an orientation of the target object utilizing the extracted image attributes and generate a transformed pattern from the initial pattern utilizing at least one of: the estimated shape, size, and orientation of the target object, the transformed pattern being superimposed on the target object.

### BRIEF DESCRIPTION OF THE DRAWINGS

Various aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a computing device in which techniques for providing a virtual fingernail cosmetic experience disclosed herein may be implemented in accordance with various embodiments.

FIG. 2 illustrates a schematic block diagram of the computing device in FIG. 1 in accordance with various embodiments.

FIG. 3 illustrates an example whereby graphics objects such as nail polish objects are applied to target regions for simulating the appearance of nail polish applied to the individual's fingernails in accordance with various embodiments.

FIG. 4 is a flowchart for providing a virtual fingernail cosmetic experience utilizing the computing device of FIG. 1 in accordance with various embodiments.

FIG. 5 illustrates an example of a user interface where an individual's fingernail regions and special effects in the form of nail polish are displayed to the user in accordance with various embodiments.

FIG. 6 illustrates analysis of local color features of the reference point in FIG. 5 specified by the user in accordance with various embodiments.

FIG. 7 illustrates use of a local gradient feature by the finger region analyzer for estimating the target fingernail regions in accordance with various embodiments.

FIG. 8 illustrates application of nail polish objects by the special effects component onto the target fingernail regions estimated by the finger region analyzer in accordance with various embodiments.

### DETAILED DESCRIPTION

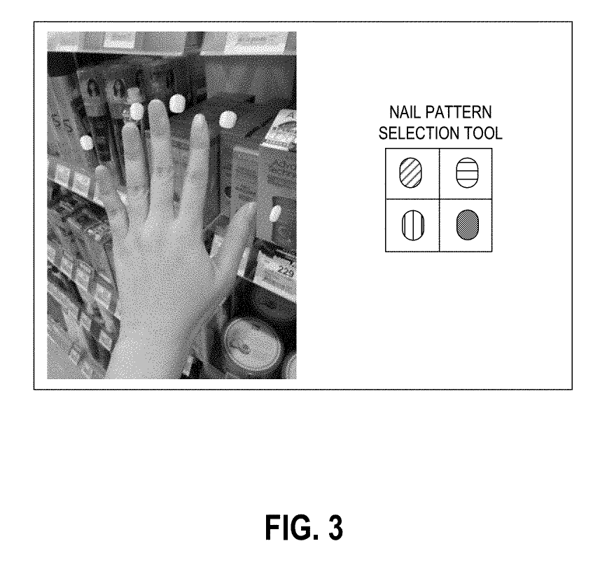

Various embodiments are disclosed for accurately performing object recognition and pose estimation for purposes of applying special effects to one or more target regions. The special effects may comprise, but are not limited to, one or more graphics applied to the fingernail regions of individuals depicted in a digital image. For example, graphics objects (e.g., nail polish objects) may be applied to simulate the appearance of nail polish applied to the individual's fingernails, as illustrated in FIG. 3. When utilizing computerized imaging during the editing process, the system must identify the precise location, size, shape, etc. of each of the fingernails, otherwise special effects (e.g., application of nail polish) may be inadvertently applied to regions outside the fingernail regions, thereby yielding an undesirable result.

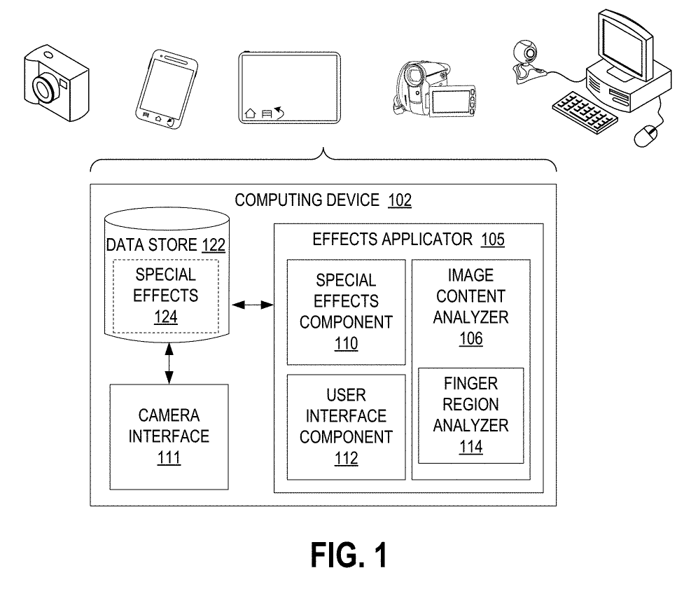

Various embodiments achieve the technical effect of accurately identifying the location, shape, and size of the fingernail regions and applying special effects (e.g., nail polish) to the identified fingernail regions. FIG. 1 is a block diagram of a computing device 102 in which the feature detection and image editing techniques disclosed herein may be implemented. The computing device 102 may be embodied as a computing device equipped with digital content recording capabilities such as, but not limited to, a digital camera, a smartphone, a tablet computing device, a digital video recorder, a laptop computer coupled to a webcam, and so on.

An effects applicator 105 executes on a processor of the computing device 102 and includes various components including an image content analyzer 106, a special effects component 110, and a user interface component 112. The image content analyzer 106 is configured to analyze the content of digital images captured by the camera module 111 and/or received from a remote source. The image content analyzer 106 may also be configured to analyze content of digital images stored on a storage medium such as, by way of example and without limitation, a compact disc (CD), a universal serial bus (USB) flash drive, or cloud storage, wherein the digital images may then be transferred and stored locally on a hard drive of the computing device 102.

The digital images processed by the image content analyzer 106 may be received by a media interface component (not shown) and encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or other digital formats.

Note that the digital images may also be extracted from media content encoded in other formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), or any number of other digital formats.

The image content analyzer 106 determines characteristics of the content depicted in digital images and includes a finger region analyzer 114. The finger region analyzer 114 analyzes attributes of each individual depicted in the digital images and estimates the location, size and shape of the target region (e.g., the individual's fingernails). Based on the estimated location, size, and shape of the individual's fingernails, the special effects component 110 applies one or more cosmetic special effects (e.g., nail polish objects) to the identified target regions. For example, the special effects component 110 may apply a particular color of nail polish to the individual's fingernail regions estimated by the finger region analyzer 114.

The user interface component 112 is configured to provide a user interface to the user of the image editing device and allow the user to provide various inputs such as the selection of special effects and the location of a reference point within the target region, where the special effects 124 selected by user may be obtained from a data store 122 in the computing device 102. The special effects component 110 then applies the obtained special effect 124 to the target region identified by the facial feature identifier 116.

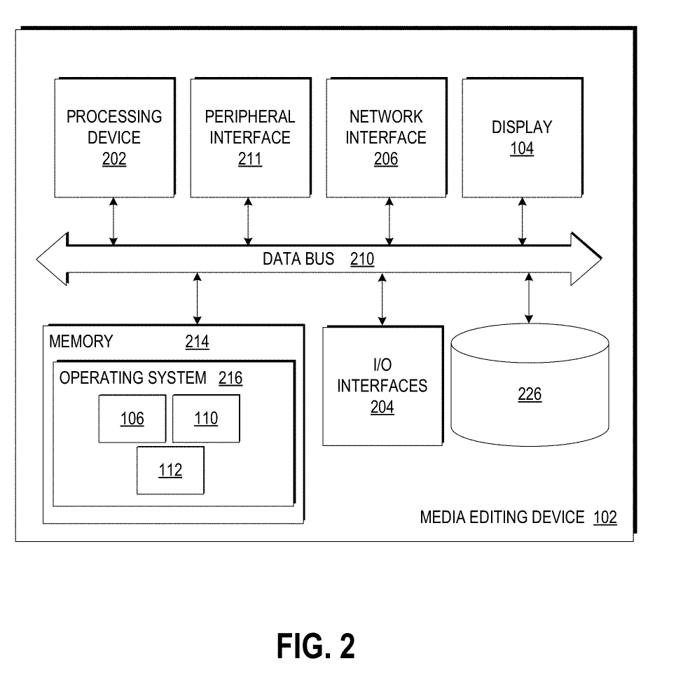

FIG. 2 illustrates a schematic block diagram of the computing device 102 in FIG. 1. The computing device 102 may be embodied in any one of a wide variety of wired and/or wireless computing devices, such as a desktop computer, portable computer, dedicated server computer, multiprocessor computing device, smart phone, tablet, and so forth. As shown in FIG. 2, each of the computing device 102 comprises memory 214, a processing device 202, a number of input/output interfaces 204, a network interface 206, a display 104, a peripheral interface 211, and mass storage 226, wherein each of these components are connected across a local data bus 210.

The processing device 202 may include any custom made or commercially available processor, a central processing unit (CPU) or an auxiliary processor among several processors associated with the computing device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 depicted in FIG. 1. In accordance with such embodiments, the components are stored in memory 214 and executed by the processing device 202, thereby causing the processing device 202 to perform the operations/functions relating to the image editing techniques disclosed herein. One of ordinary skill in the art will appreciate that the memory 214 can, and typically will, comprise other components which have been omitted for purposes of brevity.

Input/output interfaces 204 provide any number of interfaces for the input and output of data. For example, where the computing device 102 comprises a personal computer, these components may interface with one or more user input/output interfaces 204, which may comprise a keyboard or a mouse, as shown in FIG. 2. The display 104 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

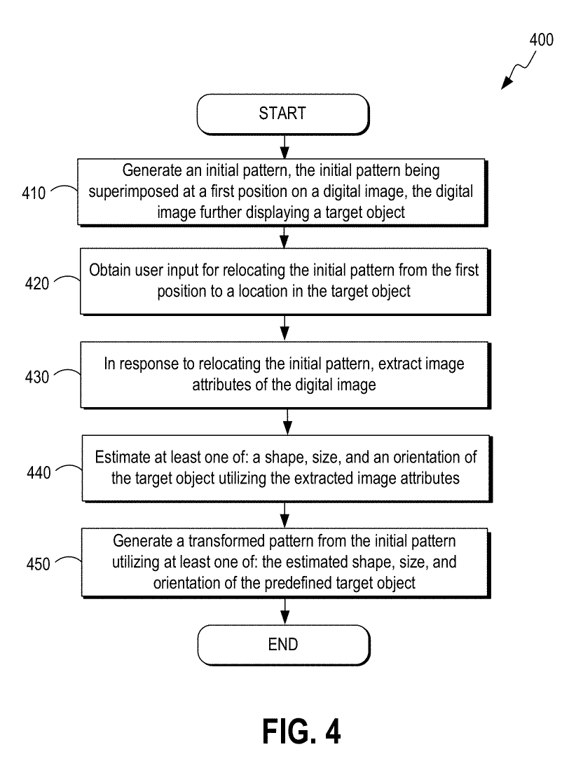

Reference is made to FIG. 4, which is a flowchart 400 of operations executed by the computing device 102 in FIG. 1 for providing a virtual fingernail cosmetic experience. It is understood that the flowchart 400 of FIG. 4 provides merely an example of the different types of functional arrangements that may be employed to implement the operation of the various components of the computing device 102 in FIG. 1. As an alternative, the flowchart 400 of FIG. 4 may be viewed as depicting an example of steps of a method implemented in the computing device 102 according to one or more embodiments.

Although the flowchart 400 of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. It is understood that all such variations are within the scope of the present disclosure.

To begin, in block 410, the user interface component 112 in the computing device 102 of FIG. 1 generates an initial pattern located at a first position on a user interface displaying a digital image, where the digital image further displays a target object. In accordance with various embodiments, the initial pattern comprises a graphic simulating fingernail polish and the target object comprises a fingernail. For some embodiments, the initial pattern is embodied as a special effect 124 and is retrieved by the special effects component 110 from the data store 122.

In block 420, the computing device obtains user input for relocating the initial pattern from the first position to a location in the target object. As discussed in more detail below, the location in the target object corresponds to a reference point located within a region of the target object and is utilized by the computing device for refining the specific placement of a transformed pattern on the target object.

In block 430, in response to relocating the initial pattern, the image content analyzer 106 extracts image attributes of the digital image. In some embodiments, the image attributes include color characteristics of pixels in the digital image.

In block 440, the finger region analyzer 114 utilizes the extracted image attributes to estimate at least one of: a shape, size, and an orientation of the target object. This facilitates accurate placement of the pattern comprising a graphic simulating fingernail polish on the target object comprising a fingernail.

In block 450, the special effects component 110 generates a transformed pattern from the initial pattern utilizing the at least one of: the estimated shape, size, and orientation of the target object. Specifically, the transformed pattern is a refined version of the initial pattern comprising a graphic simulating fingernail polish on and results in accurate placement of the pattern on the target object comprising a fingernail.

Thereafter, the process in FIG. 4 ends.

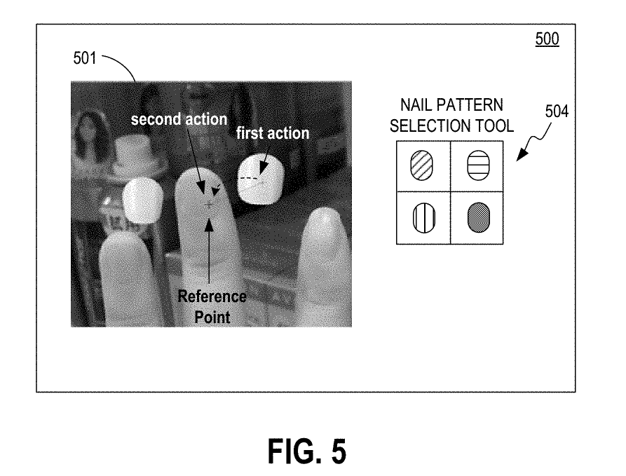

To further illustrate various functions/algorithm discussed in connection with the flowchart of FIG. 3, reference is made to FIGS. 5-8. To begin, as shown in FIG. 5, the user interface component 112 generates a user interface 500 displaying a digital image 501 that includes an initial pattern comprising a graphic simulating fingernail polish. The digital image 501 also includes target objects comprising fingernail regions. As shown, a selection tool 504 is provided, where the color and other attributes of the nail polish may be selected by the user. In some implementations, the selection tool 504 may be either superimposed on the digital image 501 or displayed in an area in the user interface 500 separate from the digital image 501. The user can either apply the same nail pattern (i.e., initial pattern) to all the fingernail regions or apply a combination of different nail patterns to the fingernail regions.

The user then “applies” nail polish by relocating the selected nail polish object(s) from the selection tool 504 to reference points within the target regions (i.e., fingernail regions). For some embodiments, the user relocates a nail pattern to a reference point by performing a two-step process comprising a first action and a second action. Specifically, the user may click on the nail polish object as a first action and then click on a reference point as a second action within the corresponding target region. For other embodiments, the user may relocate the nail polish object to the reference point using multiple actions where a first action comprises a touch down action (i.e., the user touches a touchscreen) and a second action comprises a touch up action whereby the user moves finger away from the panel. Note that the second action can alternatively comprise a touch down action.

In the example shown, the nail polish object and the specified reference point within the target fingernail region are highlighted. For various embodiments, the finger region analyzer 114 analyzes attributes of the fingernail region (e.g., color) for purposes of estimating the pose based on the specified reference point where the estimated pose includes such characteristics as shape, size, location, rotation angle, etc. of the fingernail region.

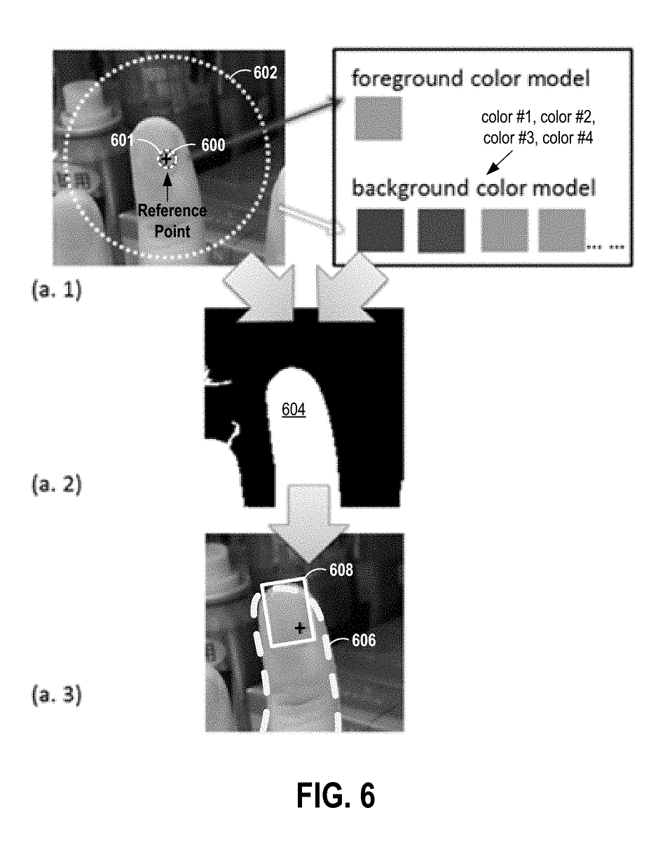

Reference is made to FIG. 6, which illustrates analysis of local color features of the reference point in FIG. 5 specified by the user. In step a.1, the finger region analyzer 114 (FIG. 1) generates an estimated foreground color model corresponding to the entire fingernail region according to the pixels within a boundary 601 surrounding the user-specified reference point 600 (i.e., the pixels inside the smaller dashed-line circle shown in FIG. 6). For some embodiments, the finger region analyzer 114 also generates a background model according to pixels located outside a threshold distance relative to the user-specified reference point 600. The color model may be generated by an unsupervised learning method such as, for example, K-means, use of a Gaussian mixture model, and so on. The outer boundary 602 for generating the background model is shown by the larger dotted-line circle shown in FIG. 5.

In step a.2, the finger region analyzer 114 segments the foreground and the background according to the estimated foreground and background color models. The foreground and the background of the image are segmented based on the derived color models. For some embodiments, this may comprise generating a mask 604. All the image pixels are analyzed. Image pixel values that are closer to values in the foreground color model become part of the foreground mask. Similarly, image pixel values that are closer to values in the background color model become part of the background mask. In step a.3, the finger region analyzer 114 derives a finger contour 606 according to the segmentation result. The finger region analyzer 114 then estimates the target fingernail region 608 according to the finger contour 606. For some embodiments, the top of the fingernail region 608 is estimated according to the maximum curvature of the estimated finger contour 606. The corners of the fingernail region 608 are estimated according to the points on the contour within a certain distance from the top of the fingernail region 608, where the distance is measured along the finger contour 606.

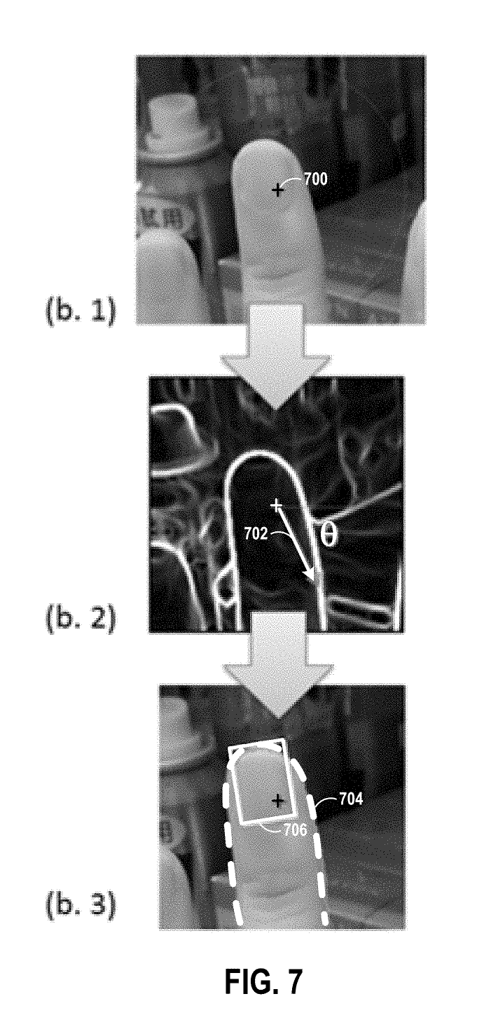

An alternative algorithm for estimating the target fingernail regions is now disclosed. Reference is made to FIG. 7, which illustrates use of a local gradient feature by the finger region analyzer 114 for precisely estimating the target fingernail regions. In step b.1, the finger region analyzer 114 receives a reference point 700 from the user, the reference point 700 being located within the target fingernail region. The finger region analyzer 114 then computes a gradient map for the image region of interest around the user-specified reference point 700. In step b.2, the finger region analyzer 114 traces a gradient magnitude 702 on the gradient map from the position of the user-specified reference point 700 for each sampling angle θ.

The step of tracing a gradient magnitude 702 along the arrow shown in FIG. 7(b.2) is performed until the finger region analyzer 114 encounters a location where the gradient magnitude exceeds a threshold magnitude. This location where the gradient magnitude exceeds the threshold magnitude is designated as a stop point and is part of the boundary line, which is utilized for constructing the contour 704 of the finger. In step b.3, the finger region analyzer 114 connects the stop point of each sampling angle to generate the contour 704. The finger region analyzer 114 then estimates the target fingernail region 706 according to the contour 704.

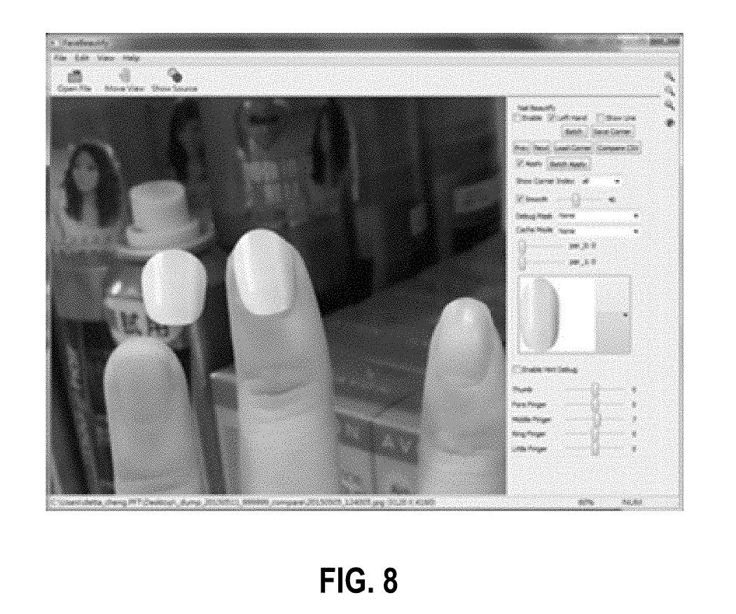

FIG. 8 illustrates application of nail polish objects by the special effects component 110 onto the target fingernail regions estimated by the finger region analyzer 114.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a computing device having a processor, memory, and a display, the method for providing a virtual fingernail cosmetic experience, comprising:
generating an initial pattern, the initial pattern being superimposed at a first position on a user interface displaying a digital image, the digital image further displaying a target object, wherein the initial pattern comprises a graphic simulating fingernail polish and the target object comprises a fingernail;
obtaining user input for relocating the initial pattern from the first position to a location in the target object;
in response to relocating the initial pattern, extracting image attributes of the digital image;
estimating at least one of: a shape, size, and an orientation of the target object utilizing the extracted image attributes; and
generating a transformed pattern from the initial pattern utilizing the at least one of: the estimated shape, size, and orientation of the target object, the transformed pattern being superimposed on the target object.

2. The method of claim 1, wherein the user input for relocating the initial pattern comprises a first user input and a second user input.

3. The method of claim 2, wherein the display comprises a touch panel display, and wherein the first user input comprises a first action performed on the touch panel display.

4. The method of claim 3, wherein the second user input comprises a second action performed on the touch panel display.

5. The method of claim 4, wherein the image attributes comprise at least one of: a color feature or a gradient map.

6. The method of claim 5, further comprising utilizing the color feature to estimate a boundary of the target object, wherein the color feature comprises at least one color model generated for pixels located within a threshold distance from a location in the digital image corresponding to a location where the second action was performed on the touch panel display.

7. The method of claim 5, further comprising utilizing the gradient map to estimate a boundary of the target object based on locations where gradients in the gradient map exceed a threshold magnitude relative to a location in the digital image corresponding to a location where the second action was performed on the touch panel display.

8. A system, comprising:
a display;
a memory device storing instructions; and
a processor coupled to the memory device and configured by the instructions to at least:
generate an initial pattern, the initial pattern being superimposed at a first position on a user interface displaying a digital image, the digital image further displaying a target object, wherein the initial pattern comprises a graphic simulating fingernail polish and the target object comprises a fingernail;
obtain user input for relocating the initial pattern from the first position to a location in the target object;
in response to relocating the initial pattern, extract image attributes of the digital image;
estimate at least one of: a shape, size, and an orientation of the target object utilizing the extracted image attributes; and
generate a transformed pattern from the initial pattern utilizing the at least one of: the estimated shape, size, and orientation of the target object, the transformed pattern being superimposed on the target object.

9. The system of claim 8, wherein the user input for relocating the initial pattern comprises a first user input and a second user input.

10. The system of claim 9, wherein the display comprises a touch panel display, and wherein the first user input comprises a first action performed on the touch panel display.

11. The system of claim 10, wherein the second user input comprises a second action performed on the touch panel display.

12. The system of claim 11, wherein the image attributes comprise at least one of: a color feature or a gradient map.

13. The system of claim 12, wherein the processor is further configured to utilize the color feature to estimate a boundary of the target object, wherein the color feature comprises at least one color model generated for pixels located within a threshold distance from a location in the digital image corresponding to a location where the second action was performed on the touch panel display.

14. The system of claim 12, wherein the processor is further configured to utilize the gradient map to estimate a boundary of the target object based on locations where gradients in the gradient map exceed a threshold magnitude relative to a location in the digital image corresponding to a location where the second action was performed on the touch panel display.

15. A non-transitory computer-readable storage medium storing instructions to be implemented by a computing device having a processor, wherein the instructions, when executed by the processor, cause the computing device to at least:
generate an initial pattern, the initial pattern being superimposed at a first position on a user interface displaying a digital image, the digital image further displaying a target object, wherein the initial pattern comprises a graphic simulating fingernail polish and the target object comprises a fingernail;
obtain user input for relocating the initial pattern from the first position to a location in the target object;
in response to relocating the initial pattern, extract image attributes of the digital image;
estimate at least one of: a shape, size, and an orientation of the target object utilizing the extracted image attributes; and
generate a transformed pattern from the initial pattern utilizing the at least one of: the estimated shape, size, and orientation of the target object, the transformed pattern being superimposed on the target object.

16. The non-transitory computer-readable storage medium of claim 8, wherein the user input for relocating the initial pattern comprises a first user input and a second user input.

17. The non-transitory computer-readable storage medium of claim 16, wherein, wherein the display comprises a touch panel display, and wherein the first user input comprises a first action performed on the touch panel display, and wherein the second user input comprises a second action performed on the touch panel display.

18. The non-transitory computer-readable storage medium of claim 17, wherein the image attributes comprise at least one of: a color feature or a gradient map.

19. The non-transitory computer-readable storage medium of claim 18, wherein the processor is further configured to utilize the color feature to estimate a boundary of the target object, wherein the color feature comprises at least one color model generated for pixels located within a threshold distance from a location in the digital image corresponding to a location where the second action was performed on the touch panel display.

20. The non-transitory computer-readable storage medium of claim 18, wherein the processor is further configured to utilize the gradient map to estimate a boundary of the target object based on locations where gradients in the gradient map exceed a threshold magnitude relative to a location in the digital image corresponding to a location where the second action was performed on the touch panel display.
